(19) United States
(12) Patent Application Publication
(10) Pub. No.: US 2012/0020647 A1
(43) Pub. Date: Jan. 26, 2012

(54) FILTERING REPEATED CONTENT

(75) Inventor: Brian K. Vogel, Weidman, MI (US)

(73) Assignee: ROVI TECHNOLOGIES CORPORATION, Santa Clara, CA (US)

(21) Appl. No.: 12/840,731

(22) Filed: Jul. 21, 2010

(51) Int. Cl. H04N 9/80

(52) U.S. Cl. 386/251; 386/E09.011

(57) ABSTRACT

A fingerprint generator generates at least one fingerprint based on a portion of an input content stream and communicates the at least one fingerprint to a content recognizer. A content stream selector receives a media content identifier from the content recognizer corresponding to the at least one fingerprint and performs filtering on a portion of the input content stream containing a clip, the clip corresponding to the media content identifier.

### BACKGROUND

1. Field

Example aspects of the invention generally relate to managing video, television programs, music and/or other media content.

2. Related Art

Commercial skipping is a feature that makes it possible to skip commercials in recorded programs. Some video recorders skip advertisements by detecting specific audio tracks provided for many programs, such as a brief period of silence or other predetermined audio or video segments. Others permit users to skip or fast forward through a segment a predetermined interval of time.

In response to consumer complaints that personal (or digital) video recording (PVR or DVR, respectively) software causes recorded files to take up too much hard disk space, some independent developers have developed software that causes the commercial segments to be skipped or permanently removed from the recorded video files.

One technical challenge in developing a robust content filter is to remove only content other than the show while leaving the show intact. Another technical challenge involves providing the user with the ability to adjust parameters that specify whether and to what extent content is filtered before the actual filtering is performed.

### BRIEF DESCRIPTION

The example embodiments described herein meet the above-identified needs by providing methods, systems and computer readable-medium for filtering a content stream.

In one embodiment, a fingerprint generator generates at least one fingerprint based on a portion of an input content stream and communicates the at least one fingerprint to a content recognizer. A content stream selector receives a media content identifier from the content recognizer corresponding to the at least one fingerprint and performs filtering on a portion of the input content stream containing a clip, the clip corresponding to the media content identifier.

In another embodiment, a content stream is performed by generating at least one fingerprint based on a portion of an input content stream; communicating the at least one fingerprint to a content recognizer; receiving a media content identifier from the content recognizer corresponding to the at least one fingerprint; and filtering a portion of the input content stream containing a clip, the clip corresponding to the media content identifier. In yet another embodiment, these steps are stored as instructions in a non-transitory computer-readable medium, which when executed by a processor perform the content stream filtering.

Further features and advantages, as well as the structure and operation, of various example embodiments of the invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the following drawings.

FIG. 1 is a system diagram of an exemplary content removal system in which some embodiments are implemented.

FIG. 2 is a block diagram of an example home network in which some embodiments are implemented.

FIG. 3 illustrates a content removal system and provides a more detailed diagram of a filter in accordance with some embodiments.

FIG. 4 is a timing diagram showing an input stream being filtered in accordance with an example embodiment.

FIG. 5 is another timing diagram showing an input stream being filtered in accordance with an example embodiment.

FIG. 6 depicts a flow diagram for a content filtering system that can be used to perform filtering methods.

FIG. 7 is a block diagram of a general and/or special purpose computer, in accordance with some embodiments.

### DETAILED DESCRIPTION

### I. Overview

The example embodiments of the invention presented herein are directed to methods, systems and computer program products for removing repeated content, which are described in terms of an example consumer device which filters content streams by using audio recognition. This description is not intended to limit the application of the example embodiments presented herein. In fact, after reading the following description, it will be apparent to one skilled in the relevant art(s) how to implement the following example embodiments in alternative embodiments, such as a service hosting or providing media content streaming. Similarly, recognition may be accomplished by using video recognition or other type of media content recognition.

In one embodiment, previously played content is removed from a content stream. The user can adjust parameters that specify the maximum repetition count, such as the length or duration of the time window over which the system keeps track of the previously viewed content. Content that has been previously played a predetermined number of times can be filtered by either removing or replacing it with other content based on the parameter settings. It should be understood that the type of filtering performed on the data stream can vary. Filtering can be removing a portion of the content stream, replacing the original data stream, processing the content stream to produce a derivative of the original data stream, and the like.

In an exemplary use case for video, a TV program that has been recorded for later viewing using a DVR can be filtered. Typical TV programs contain a number of short repeating video clips, such as commercials. By automatically filtering out the clips that have already been played a predetermined number of times, a user need not waste time watching and manually skipping over them.

In another exemplary use case for Internet, analog, and satellite radio stations that air the same content such as songs, commercials, and announcements, several times within a predetermined period can be filtered. A theme song that has been played a predetermined number of times within a given time period, for example, can also be filtered by taking the theme song out or replacing it with alternate content.

In accordance with an exemplary embodiment, a device is programmed to receive content streams from one or more predetermined stations, identify pre-selected content clips such as songs and/or commercials that occur more than the preset repetition count in the stream, and removes subsequent occurrences of those pre-selected content clips. The output of the system is a content stream such that the pre-selected content clips (e.g., songs, commercials, and announcements) now occur at most a predetermined number of times.

### II. Definitions

“Album” means a collection of tracks. An album is typically originally published by an established entity, such as a record label (e.g., a recording company such as Warner Brothers and Universal Music).

“Audio Fingerprint” and “acoustic fingerprint” mean a measure of certain acoustic properties that is deterministically generated from an audio signal that can be used to identify an audio sample and/or quickly locate similar items in an audio database. An audio fingerprint typically operates as a unique identifier for a particular item, such as, for example, a CD, a DVD and/or a Blu-ray Disc. An audio fingerprint is an independent piece of data that is not affected by metadata. Rovi™ Corporation has databases that store over 25 million unique fingerprints for various audio samples. Practical uses of audio fingerprints include without limitation identifying songs, identifying records, identifying melodies, identifying tunes, identifying advertisements, monitoring radio broadcasts, monitoring multipoint and/or peer-to-peer networks, managing sound effects libraries and identifying video files.

“Audio Fingerprinting” is the process of generating an audio fingerprint. U.S. Pat. No. 7,277,766, entitled “Method and System for Analyzing Digital Audio Files”, which is herein incorporated by reference, provides an example of an apparatus for audio fingerprinting an audio waveform. U.S. Pat. No. 7,451,078, entitled “Methods and Apparatus for Identifying Media Objects”, which is herein incorporated by reference, provides an example of an apparatus for generating an audio fingerprint of an audio recording. U.S. patent application Ser. No. 12/686,779, entitled “Rolling Audio Recognition”, which is herein incorporated by reference, provides an example of an apparatus for performing rolling audio recognition of recordings. U.S. patent application Ser. No. 12/686,804, entitled “Multi-Stage Lookup For Rolling Audio Recognition” provides an example of performing a multi-stage lookup for rolling audio recognition, both of which are herein incorporated by reference.

“Blu-ray” and “Blu-ray Disc” mean a disc format jointly developed by the Blu-ray Disc Association and personal computer and media manufacturers including Apple, Dell, Hitachi, HP, JVC, LG, Mitsubishi, Panasonic, Pioneer, Philips, Samsung, Sharp, Sony, TDK and Thomson. The format was developed to enable recording, rewriting and playback of high-definition (HD) video, as well as storing large amounts of data. The format offers more than five times the storage capacity of conventional DVDs and can hold 25 GB on a single-layer disc and 800 GB on a 20-layer disc. More layers and more storage capacity may be feasible as well. This extra capacity combined with the use of advanced audio and/or video codecs offers consumers an unprecedented HD experience. While current disc technologies, such as CD and DVD, rely on a red laser to read and write data, the Blu-ray format uses a blue-violet laser instead, hence the name Blu-ray. The benefit of using a blue-violet laser (about 405 nm) is that it has a shorter wavelength than a red or infrared laser (about 650-780 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc may have substantially similar physical dimensions as a traditional CD or DVD.

“Chapter” means an audio and/or video data block on a disc, such as a Blu-ray Disc, a CD or a DVD. A chapter stores at least a portion of an audio and/or video recording.

“Compact Disc” (CD) means a disc used to store digital data. The CD was originally developed for storing digital audio. Standard CDs have a diameter of 740 mm and can typically hold up to 80 minutes of audio. There is also the mini-CD, with diameters ranging from 60 to 80 mm Mini-CDs are sometimes used for CD singles and typically store up to 24 minutes of audio. CD technology has been adapted and expanded to include, without limitation, data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD. The wavelength used by standard CD lasers is about 650-780 nm, and thus the light of a standard CD laser typically has a red color.

The terms “content,” “media content,” “multimedia content,” “program,” “multimedia program,” “show,” and the like, generally mean information that is delivered via a medium for a user to experience visually and/or aurally. Examples of content include audio content, image content, video content, and digital recordings, such as photographs, television programming, movies, music, spoken audio, games, special features, scheduled media, on demand and/or pay per view content, broadcast content, multicast content, downloaded content, streamed content, and/or content delivered by another means.

“Content source” means an originator, provider, publisher, distributor and/or broadcaster of content. Example content sources include television broadcasters, radio broadcasters, Web sites, printed media publishers, magnetic or optical media publishers, and the like.

“Content stream,” “data stream,” “audio stream,” “video stream,” “multimedia stream” and the like means data that is transferred at a rate sufficient to support such applications that play multimedia content. “Content streaming,” “data streaming,” “audio streaming,” “video streaming,” “multimedia streaming,” and the like mean the continuous transfer of data across a network. The content stream can include any form of content such as broadcast, cable, Internet or satellite radio and television, audio files, video files.

“Database” means a collection of data organized in such a way that a computer program may quickly select desired pieces of the data. A database is an electronic filing system. In some implementations, the term “database” may be used as shorthand for “database management system”.

“Device” means software, hardware, or a combination thereof. A device may sometimes be referred to as an apparatus. Examples of a device include without limitation a software application such as Microsoft Word™, a laptop computer, a database, a server, a display, a computer mouse, and a hard disk.

“DLNA” (Digital Living Network Alliance) is a standard used by manufacturers of consumer electronics to allow entertainment devices within the home to share their content with each other across a home network. A network may be a DLNA-compliant network.

“Digital Video Disc” (DVD) means a disc used to store digital data. The DVD was originally developed for storing digital video and digital audio data. Most DVDs have substantially similar physical dimensions as compact discs (CDs), but DVDs store more than six times as much data. There is also the mini-DVD, with diameters ranging from 60 to 80 mm DVD technology has been adapted and expanded to include DVD-ROM, DVD-R, DVD+R, DVD-RW, DVD+RW and DVD-RAM. The wavelength used by standard DVD lasers is about 605-650 nm, and thus the light of a standard DVD laser typically has a red color.

“Electronic program guide” or “EPG” data provides a guide for scheduled broadcast television. A guide may be displayed on-screen and can be used to allow a viewer to navigate, select, and discover content by time, title, channel, genre, etc. by use of a remote control, a keyboard, or other similar input devices. In addition, EPG data can be used to schedule future recording by a digital video recorder (DVR) or personal video recorder (PVR).

“Fuzzy search,” “fuzzy string search” and “approximate string search” mean a search for text strings that approximately or substantially match a given text string pattern. Fuzzy searching may also be known as approximate or inexact matching. An exact match may inadvertently occur while performing a fuzzy search.

“Link” means an association with an object or an element in a memory. A link is typically a pointer. A pointer is a variable that contains the address of a location in memory. The location is the starting point of an allocated object, such as an object or value type, or the element of an array. The memory may be located on a database or a database system. “Linking” means associating with, or pointing to, an object in memory.

“Media item” means an item of media content.

“Media item attribute” means a metadata item corresponding to particular characteristics of a media item. Each media item attribute falls under a particular media item attribute category. Examples of media item attribute categories and associated media item attributes for music include cognitive attributes (e.g., simplicity, storytelling quality, melodic emphasis, vocal emphasis, speech like quality, strong beat, good groove, fast pace), emotional attributes (e.g., intensity, upbeatness, aggressiveness, relaxing, mellowness, sadness, romance, broken heart), aesthetic attributes (e.g., smooth vocals, soulful vocals, high vocals, sexy vocals, powerful vocals, great vocals), social behavioral attributes (e.g., easy listening, wild dance party, slow dancing, workout, shopping mall), genre attributes (e.g., alternative, blues, country, electronic/dance, folk, gospel, jazz, Latin, new age, R&B/soul, rap/hip hop, reggae, rock), sub genre attributes (e.g., blues, gospel, motown, stax/memphis, philly, doo wop, funk, disco, old school, blue eyed soul, adult contemporary, quiet storm, crossover, dance/techno, electro/synth, new jack swing, retro/alternative, hip hop, rap), instrumental/vocal attributes (e.g., instrumental, vocal, female vocalist, male vocalist), backup vocal attributes (e.g., female vocalist, male vocalist), instrument attributes (e.g., most important instrument, second most important instrument), etc.

Examples of media item attribute categories and associated attributes for content include genre (e.g., action, animation, children and family, classics, comedy, documentary, drama, faith and spirituality, foreign, high definition, horror, independent, musicals, romance, science fiction, television, thrillers), release date (e.g., within past six months, within past year, 1980s), etc.

Other media item attribute categories and media item attributes are contemplated and are within the scope of the embodiments described herein.

“Media item fingerprint”, “fingerprint”, “digital fingerprint”, and “signature” mean a measure of certain physical properties that is deterministically generated from a digital signal that can be used to identify a sample of a media item, and/or quickly locate similar media items in a database. Example media item fingerprints include an audio fingerprint, a video fingerprint, and/or a digital signature of any other digital media object. A fingerprint may also be a watermark or other identifier, such as text from the media item or associated file or record that can be used to identify the media item. Examples of a signature include without limitation the following in a computer-readable format: an audio fingerprint, a portion of an audio fingerprint, a signature derived from an audio fingerprint, an audio signature, a video signature, a disc signature, a CD signature, a DVD signature, a Blu-ray Disc signature, a media signature, a high definition media signature, a human fingerprint, a human footprint, an animal fingerprint, an animal footprint, a handwritten signature, an eye print, a biometric signature, a retinal signature, a retinal scan, a DNA signature, a DNA profile, a genetic signature and/or a genetic profile, among other signatures. A signature may be any computer-readable string of characters that comports with any coding standard in any language. Examples of a coding standard include without limitation alphabet, alphanumeric, decimal, hexadecimal, binary, American Standard Code for Information Interchange (ASCII), Unicode and/or Universal Character Set (UCS). Certain signatures may not initially be computer-readable. For example, latent human fingerprints may be printed on a door knob in the physical world. A signature that is initially not computer-readable may be converted into a computer-readable signature by using any appropriate conversion technique. For example, a conversion technique for converting a latent human fingerprint into a computer-readable signature may include a ridge characteristics analysis.

“Metadata,” “media content metadata” and “content information,” generally mean data that describes data. More particularly, metadata refers to information associated with or related to one or more items of media content and may include information used to access the media content. The metadata provided and/or delivered by various embodiments is designed to meet the needs of the user in providing a rich media metadata browsing experience. Such metadata may include, for example, a track name, a song name, artist information (e.g., name, birth date, discography), album information (e.g., album title, review, track listing, sound samples), relational information (e.g., similar artists and albums, genre), and/or other types of supplemental information such as advertisements, links or programs (e.g., software applications), and related images. Metadata may also include a program guide listing of the songs or other audio content associated with multimedia content. Conventional optical discs (e.g., CDs, DVDs, Blu-ray Discs) do not typically contain metadata. Metadata may be associated with content (e.g., a song, an album, a movie or a video) after the content has been ripped from an optical disc, converted to another digital audio format, and stored on a hard drive. Metadata may be stored together with, or separately from, the underlying content that is described by the metadata.

“Network” means a connection between any two or more computers, which permits the transmission of data. A network may be any combination of networks, including without limitation the Internet, a network of networks, a local area network (e.g., home network, intranet), a wide area network, a wireless network, and a cellular network.

“Occurrence” means a copy of a recording. An occurrence is preferably an exact copy of a recording. For example, different occurrences of a same pressing are typically exact copies. However, an occurrence is not necessarily an exact copy of a recording, and may be a substantially similar copy. A recording may be an inexact copy for a number of reasons, including without limitation an imperfection in the copying process, different pressings having different settings, different copies having different encodings, and other reasons. Accordingly, a recording may be the source of multiple occurrences that may be exact copies or substantially similar copies. Different occurrences may be located on different devices, including without limitation different user devices, different MP3 players, different databases, different laptops, and so on. Each occurrence of a recording may be located on any appropriate storage medium, including without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device. Occurrences may be compiled, such as in a database or in a listing.

“Pressing” (e.g., “disc pressing”) means producing a disc in a disc press from a master. The disc press preferably produces a disc for a reader that utilizes a laser beam having a wavelength of about 650-780 nm for CD, about 605-650 nm for DVD, about 405 nm for Blu-ray Disc or another wavelength as may be appropriate.

“Recording” means media data for playback. A recording is preferably a computer readable recording and may be, for example, an audio track, a video track, a song, a chapter, a CD recording, a DVD recording and/or a Blu-ray Disc recording, among other things.

“Server” means a software application that provides services to other computer programs (and their users), in the same or another computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” and “application” mean a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++, and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“Song” means a musical composition. A song is typically recorded onto a track by a record label (e.g., recording company). A song may have many different versions, for example, a radio version and an extended version.

“System” means a device or multiple coupled devices. A device is defined above.

“Theme song” means any audio content that is a portion of a multimedia program, such as a television program, and that recurs across multiple occurrences, or episodes, of the multimedia program. A theme song may be a signature tune, song, and/or other audio content, and may include music, lyrics, and/or sound effects. A theme song may occur at any time during the multimedia program transmission, but typically plays during a title sequence and/or during the end credits.

“Track” means an audio/video data block. A track may be on a disc, such as, for example, a Blu-ray Disc, a CD or a DVD.

“User” means a consumer, client, and/or client device in a marketplace of products and/or services.

“User device” (e.g., “client”, “client device”, “user computer”) is a hardware system, a software operating system, and/or one or more software application programs. A user device may refer to a single computer or to a network of interacting computers. A user device may be the client part of a client server architecture. A user device typically relies on a server to perform some operations. Examples of a user device include without limitation a television (TV), a CD player, a DVD player, a Blu-ray Disc player, a personal media device, a portable media player, an iPod™, a Zoom Player, a laptop computer, a palmtop computer, a smart phone, a cell phone, a mobile phone, an MP3 player, a digital audio recorder, a digital video recorder (DVR), a set top box (STB), a network attached storage (NAS) device, a gaming device, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox™ and Microsoft Internet Explorer™.

“Web page” means any documents written in a mark-up language including without limitation HTML (hypertext mark-up language) or VRML (virtual reality modeling language), dynamic HTML, XML (extensible mark-up language) or related computer languages thereof, any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo™ Web server.

“Web site” means at least one Web page, and more commonly a plurality of Web pages, virtually coupled to form a coherent group.

### III. System Architecture and Processes

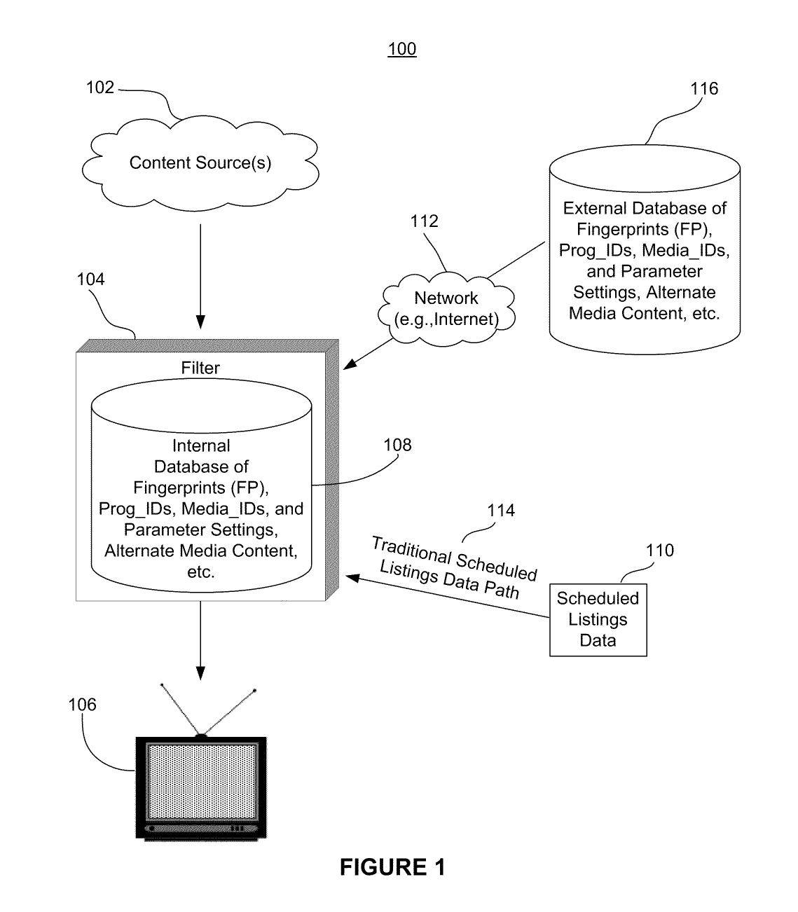

FIG. 1 is a system diagram of an exemplary content removal system 100 in which some embodiments are implemented. As shown in FIG. 1, the system 100 includes at least one content source 102 that provides multimedia content, such as a television program or other program containing video and/or audio content, to a filter 104. The content source 102 may include several different types such as, for example, cable, satellite, terrestrial, free-to-air, network and/or Internet, each of which is capable of providing media content in the form of a content stream.

Generally, filter 104 filters content that a user has already heard or viewed by removing or replacing some or all of the repeated content. The terms “heard” and “viewed” individually and collectively are referred to herein as “consumed”.

An example application is a system that removes advertisements previously consumed. The advertisements can optionally be filtered by replacing them with different media content such as a different advertisement that the user has not already consumed. This can be controlled, for example, by the same content source provider that is transmitting the original content stream, or a third party content provider. Optionally, the device can store media items provided by a user via an interface on the user's device or via a network.

As shown in FIG. 1, the filter 104 is communicatively coupled to a device 106, such as a television, an audio device, a video device, and/or another type of user and/or CE device, and outputs the multimedia content to the device 106 upon receiving the appropriate instructions from a suitable user input device (not shown), such as a remote control device or buttons located on the device 106 itself. The filter 104 can also be constructed as an integral component of the device 106.

The device 106 receives the filtered multimedia content from the filter 104, and presents the multimedia content to a user. The user controls the operation of the device 106 via a suitable user input device, such as buttons located on the device 106 itself or via a remote control. In one embodiment, a single remote control device may enable the user to control both the device 106 and the filter 104. The multimedia content provided through the filter 104 can be consumed by the user at a time chosen by the user.

The filter 104 can be integral with, located in close proximity to, or at a remote location from, device 106. An example remote location is a server of a multimedia content provider. In all cases, the filter 104 operates in a substantially similar manner.

Optionally, the filter 104 periodically receives scheduled listings data 110 via a traditional scheduled listings data path 114, which can be any network, such as a proprietary network or the Internet. The filter 104 stores the received scheduled listings data 110 in a suitable digital storage device (not shown). The scheduled listings data 110, which are typically provided by a multimedia content provider, include schedule information corresponding to specific multimedia programs, such as television programs. In particular, for each multimedia program scheduled for delivery, the scheduled listings data 110 indicate a corresponding program identifier (Prog_ID), a scheduled program start time (t_{sched}_{_{—}}_{prog}_{_{—}}ₛₜₐᵣₜ), scheduled program end time (t_{sched}_{_{—}}_{prog}_{_{—}}_{end}), and scheduled channel. The scheduled listings data 110 typically are used in conjunction with EPG data, which, as discussed above, are used to provide a digital guide for scheduled television programming. The digital guide allows a user to navigate, select, discover, and schedule recordings of content by time, title, channel, genre, etc., by use of a remote control, a keyboard, or other similar input device.

As shown in FIG. 1, filter 104 also includes an internal database 108 which is used to associate various parameter settings with particular media content. In one example embodiment, database 108 stores, in association with each individual multimedia program, a media item identifier (Media_ID), a fingerprint (FP) and parameter settings associated with a user identifier. The media identifier (Media_ID) is an identifier unique to a specific portion of a content stream received from content source 102, such as a specific advertisement for a television program. Database 108 can also be used to store media items which can be used to replace a portion of the content stream being filtered when media content replacement is enabled.

Database 108 can also store a corresponding program identifier (Prog_ID), which is an identifier unique to each specific multimedia program. As explained above the program identifier typically is received as part of the scheduled listings data 110. The program identifier and the media content identifier may be the same.

It should be understood that, although FIG. 1 shows the database 108 as being internal with respect to the filter 104, embodiments including an internal database, an external database, or a combination of both are contemplated.

Internal database 108 and/or the external database 116 may also be divided into multiple distinct databases and still be within the scope of the invention.

In one embodiment, an external database 116 is located on a server remote from the filter 104, and communicates with the filter 104 via a suitable network 112, such as a proprietary network or the Internet. In this way, as new content is generated and/or discovered, the internal database 108 can be updated by receiving the data from the external database 116 over the network 112. For example, if a new multimedia item is fingerprinted, new corresponding data can be generated, stored in the external database 116, and downloaded to the internal database 108 before the new multimedia item is delivered and/or transmitted.

The filter 104 performs an algorithm to generate (or extract) a fingerprint (FP) for the captured portion of the content. The fingerprint, in turn, is used to identify the content by matching the fingerprint to a corresponding fingerprint in a database. Such recognition can also be performed by a remote recognition server.

Preferably, only a subset of the captured portion of the content is used to generate the fingerprint. In one example, a fingerprinting procedure is executed by a processor on encoded or compressed audio data which has been converted into a stereo pulse code modulated (PCM) audio stream. Pulse code modulation is a format by which many consumer electronic products operate and internally compress and/or uncompress audio data. The fingerprinting procedure can be performed on any type of audio data file or stream, and therefore is not limited to operations on PCM formatted audio streams. Accordingly, any memory size, number of frames, sampling rates, time, and the like, can be used to perform audio fingerprinting.

The generated audio fingerprint for the captured portion of audio content is compared by the filter 104 to the data in the database 108 to determine a known multimedia item to which the portion of audio content corresponds. If the portion of audio content corresponds to a known multimedia item, the filter 104 performs an algorithm that uses, among other things, predefined parameter values, to determine whether, and how, the multimedia item should be filtered.

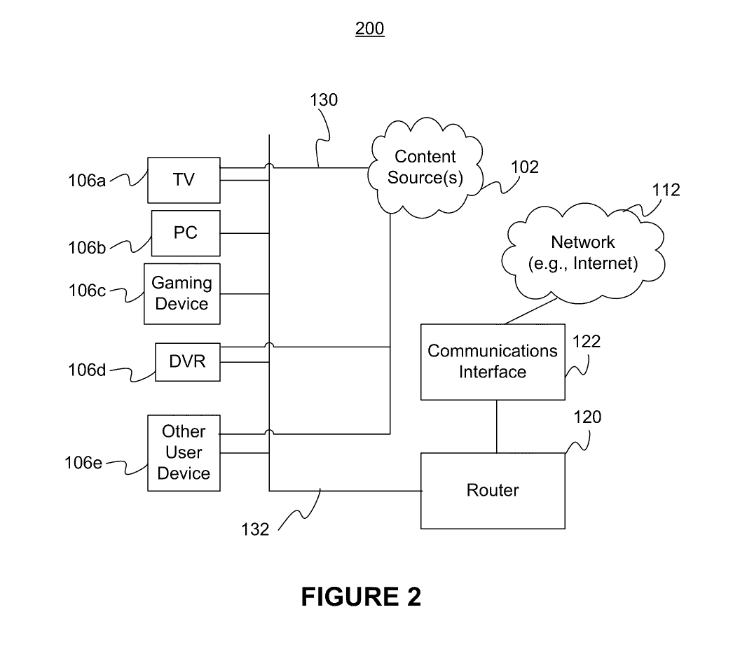

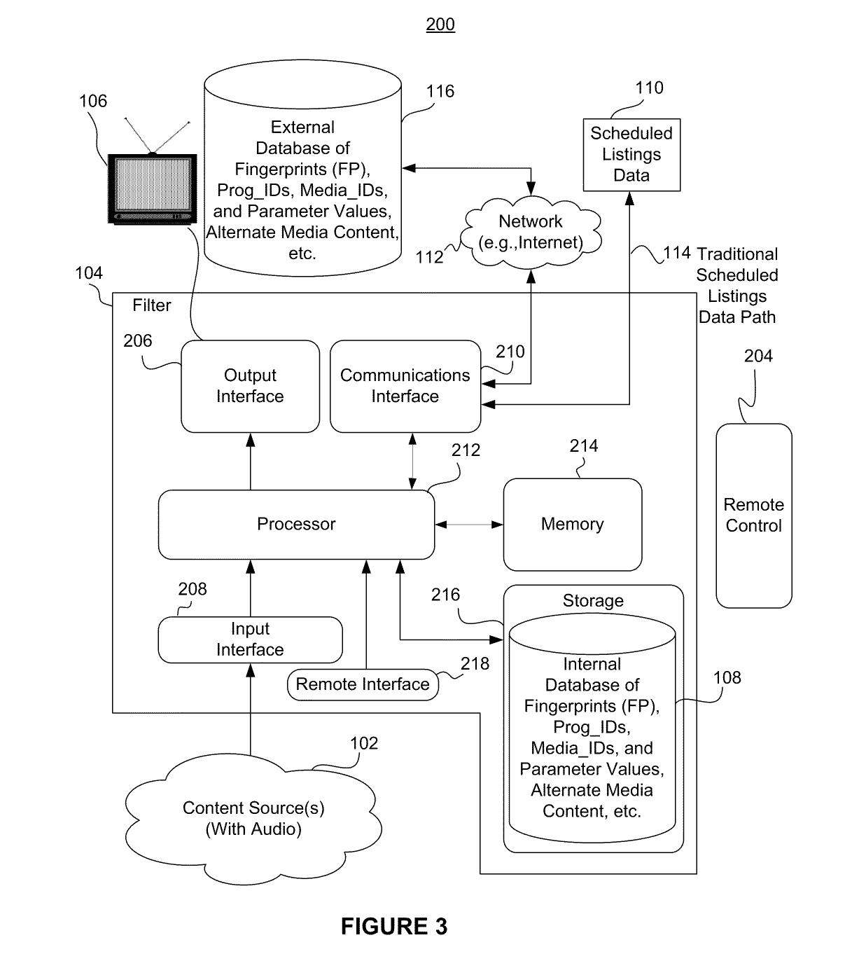

FIG. 2 is a block diagram of a network 200, in which some embodiments are implemented. The network 200 may include a home media type network, for instance. On the network 200, may be a variety of user devices, such as a network ready television 106a, a personal computer 106b, a gaming device 106c, a digital video recorder 106d, and other user devices 106e. The user devices 106a, 106b. 106c, 106d and 106e (collectively referred to as 106a-106e or 106) may receive multimedia content from content source 102 through multimedia signal lines 130, through an input interface such as the input interface 208 described below in connection with FIG. 3. In addition, user devices 106a-106e may communicate with each other through a wired or wireless router 120 via network connections 132, such as Ethernet connections. The router 120 couples the user devices 106a-106e to the network 112, such as the Internet, through a communication interface 122. In an alternative embodiment, multimedia content is obtained via network 112.

FIG. 3 illustrates a system 300 including an exemplary filter 104. Within the system 300 of FIG. 3, the filter 104 includes a processor 212 which is coupled through a communication infrastructure (not shown) to an input interface 208, an output interface 206, a communications interface 210, a memory 214, a storage device 216, and a remote control interface 218.

The input interface 208 receives content streams from the content source(s) 102, which communicate, for example, through an HDMI (High-Definition Multimedia Interface), Radio Frequency (RF) coaxial cable, composite video, S-Video, SCART, component video, D-Terminal, VGA, and the like, with the filter 104.

In the example shown in FIG. 3, content streams, such as audio and video streams, received by the input interface 208 from the content source(s) 102 are communicated to the processor 212 for further processing. The processor 212 performs fingerprinting on at least a subset of the content stream to determine whether the multimedia content contained therein should be filtered.

The filter 104 also includes a main memory 214. Preferably, the main memory 214 is random access memory (RAM). The filter 104 also includes a storage device 216. The database 108, which stores configuration data and optionally other content data used to replace portions of filtered content stream, can be included in the storage device 216. The storage device 216 (also sometimes referred to as “secondary memory”) may also include, for example, a hard disk drive and/or a removable storage drive, representing a disk drive, a magnetic tape drive, an optical disk drive, etc. As will be appreciated, the storage device 216 may include a non-transitory computer-readable storage medium having stored thereon computer software and/or data.

In alternative embodiments, the storage device 216 may include other similar devices for allowing computer programs or other instructions to be loaded into the filter 104. Such devices may include, for example, a removable storage unit and an interface, a program cartridge and cartridge interface such as that found in video game devices, a removable memory chip such as an erasable programmable read only memory (EPROM), or programmable read only memory (PROM) and associated socket, and other removable storage units and interfaces, which allow software and data to be transferred from the removable storage unit to the filter 104.

The filter 104 includes the communications interface 210 to provide connectivity to a network 112, such as a proprietary network or the Internet. The communications interface 210 also allows software and data to be transferred between the filter 104 and external devices. Examples of the communications interface 210 may include a modem, a network interface such as an Ethernet card, a communications port, a Personal Computer Memory Card International Association (PCMCIA) slot and card, etc. Software and data transferred via the communications interface 210 are in the form of signals which may be electronic, electromagnetic, optical, or other signals capable of being received by the communications interface 210. These signals are provided to and/or from the communications interface 210 via a communications path, such as a channel. This channel carries signals and may be implemented by using wire, cable, fiber optics, a telephone line, a cellular link, an RF link, and/or other suitable communications channels.

In one embodiment, the communications interface 210 provides connectivity between the filter 104 and the external database 116 via the network 112. Optionally, the communications interface 210 also provides connectivity between the filter 104 and the scheduled listings data 110 via the traditional scheduled listings data path 114. The network 112 is either a proprietary network, the Internet, or a combination of both.

A remote control interface 218 decodes signals received from a remote control 204, such as a television remote control or other user input device, and communicates the decoded signals to the processor 212. The decoded signals, in turn, are translated and processed by the processor 212.

In one exemplary embodiment, repeated content in a content stream is filtered by matching the content stream's audio and/or video fingerprint(s) to records in a database, such as database 108. When the content stream is found to contain repeating content, the repeating content is filtered based on the parameter values stored in database 108. For example, after a predetermined number of allowable repetitions the repeating content can be removed. Optionally, the repeating content that is removed can be replaced by alternate content from a local or remote database such as database 108 or 116 of FIGS. 1 and 3.

In one example, a system implementing filtering processes the content by removing advertisements that a particular user has already consumed, either automatically in accordance with prestored parameters stored in database 108 or 116 or based on commands received via a user interface such as remote control interface 218 of FIG. 3. The advertisements can be simply removed from the content or optionally be replaced with different media items, such as advertisements that the user has not already consumed.

In an exemplary embodiment, a device that is used to play the content, such as device 106 of FIG. 2, recognizes when a particular user is consuming content. For example, login information or a signature of a user may be required to access the device. A user identifier associated with the particular user is linked to a configuration record including prestored parameter values. The device filters the content based on the parameter values associated with the user.

The parameter values include a tolerance threshold for repeated content. The tolerance threshold can be in the form of an interval, such as weeks or months. For example, the configuration file of one user, User A, might contain parameter values indicating the same content may be consumed at most four times within any two week interval, while the configuration file of another user, User B, might contain parameter values indicating be the same content may be consumed three times within any two month interval. Accordingly, filter 104 can be configured to filter content based on a particular user identifier obtained during the login procedure.

The device may optionally store records on which users consumed the content, and/or which content was consumed within a stream.

More complicated filtering policies can be saved in database 108 and used to control how content is removed or replaced. By using policies, filter 104 can filter content based global parameter values. For example if one user is a teenager and another user is a child, and the device recognizes multiple users are consuming media content from the same device, the filter can be configured (or set, for example, by a parent) to remove certain content, for example from a content stream. Filtering based on media item attributes can thus take advantage of metadata associated with the content, which has been obtained from various sources. For example, filter 104 can obtain a content rating from the scheduled listings data. By comparing, for example, the rating information against corresponding preset parameter values, filter 104 can filter or replace a portion of the content, for example, by filtering or replacing a portion of a content stream. Media item attributes that can be obtained from a recognition server based on the fingerprint(s) obtained from the content stream provide a variety of other available parameter settings from which to choose.

### IV. Example Implementations

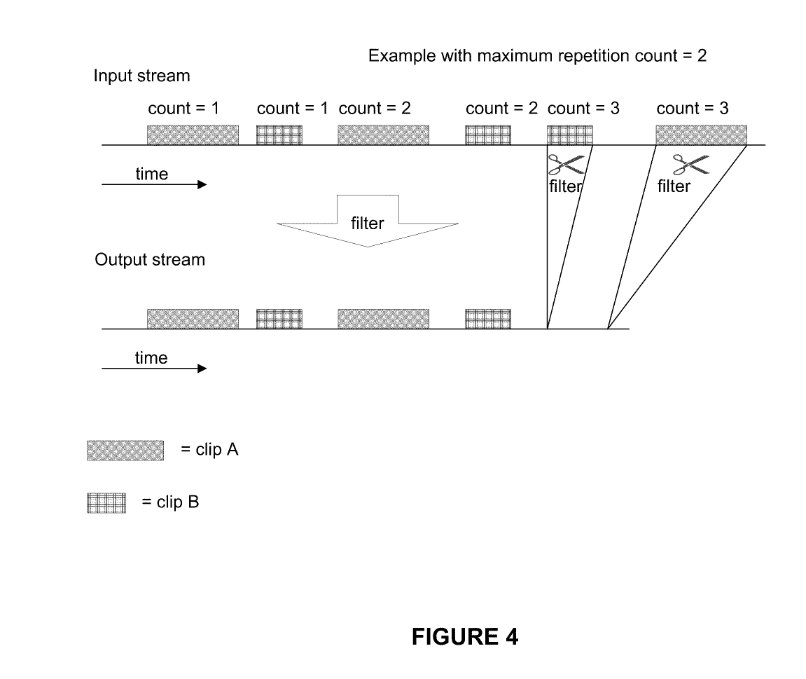

FIG. 4 is a timing diagram showing an input stream being filtered in accordance with an example embodiment. As shown in FIG. 4, the input stream is received by a filter, such as filter 104 of FIG. 3, which in turn outputs a corresponding filtered output stream. The input stream in this example includes two content clips, clip A and clip B, which may be, for example, television commercials. After clip A and clip B have been played a predetermined number of times, subsequent content streams containing the same commercial are removed so as to not appear in the output stream.

The predetermined content can be filtered as the input stream is received from its content source or after it has been recorded. For example, if the input stream has been pre-recorded, such as by using a DVR, filter 104 can perform filtering on the content before it is played back. Alternatively, the DVR can be configured to record the entire content and perform filtering after it has been saved, during playback. In yet another embodiment, the filtering can be performed in the background, when the processor 212 of FIG. 3 is executing other, unrelated program instructions.

As shown in the example of FIG. 4, clip A and clip B were removed from the content and not replaced. Accordingly, the content played back is shorter than the input stream.

When the repeated content is found in an input stream, content filtering begins and continues until the input stream no longer matches. This is accomplished by performing a rolling recognition on the input stream. When the input stream no longer matches is an indication that the repeated content has ended.

If the number of matches exceeds the filter threshold, all future matching portions of the input clip are removed or replaced. The portion of the input clip that is not filtered is sent to the output.

In the example shown in FIG. 4, the repeated content, clip A and clip B are repeated three times (e.g., count=3). Here, the parameter values have been set to filter the repeated content on the third interval. One option is to cause device 106 to produce preset output, such as a preset screen and/or sound, or no output at all. As shown in FIG. 4, both clip A and clip B have been filtered, or cut, from the input stream so that the output stream provides no output during those intervals.

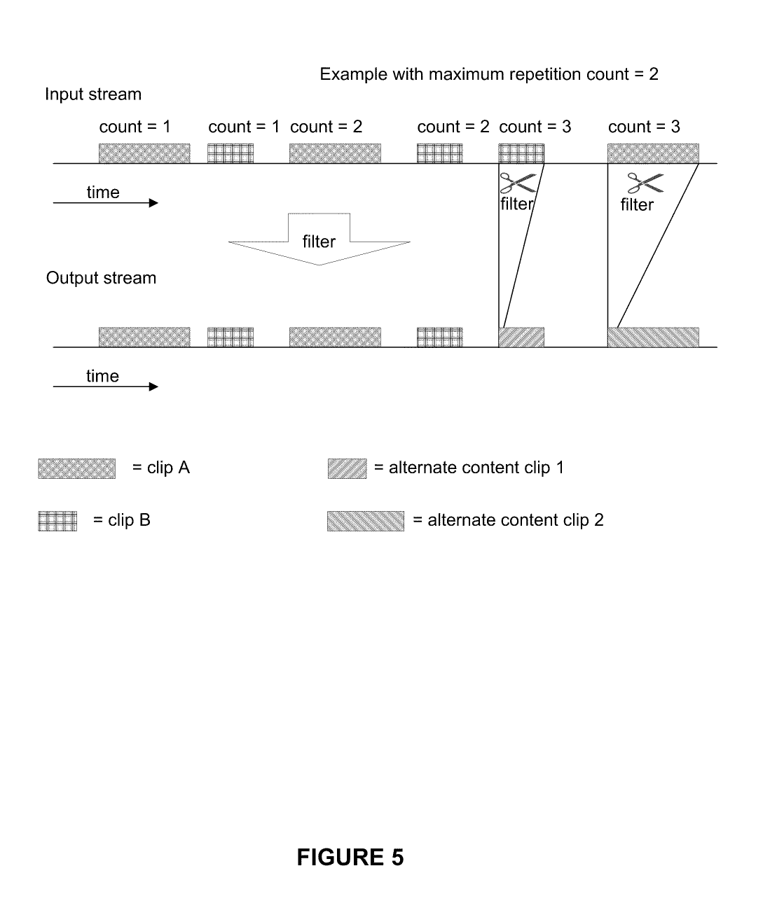

FIG. 5 is another timing diagram showing an input stream being filtered in accordance with an example embodiment. In this example, alternate content is output from the filter to the user during an interval in which repeated content is being filtered. The parameter values have been set so as to filter the repeated content on the third interval. As shown in FIG. 5, clip A is replaced with alternate clip 1 and clip B is replaced with alternate clip 2.

The length of the replacement clips, alternate clip 1 and alternate clip 2 can vary. For example, the total length of alternate clip 1 and alternate clip 2 can equal the total length of clip A and clip B. Alternatively, for example, the total length of alternate clip 1 and alternate clip 2 can be shorter than the total length of clip A and clip B.

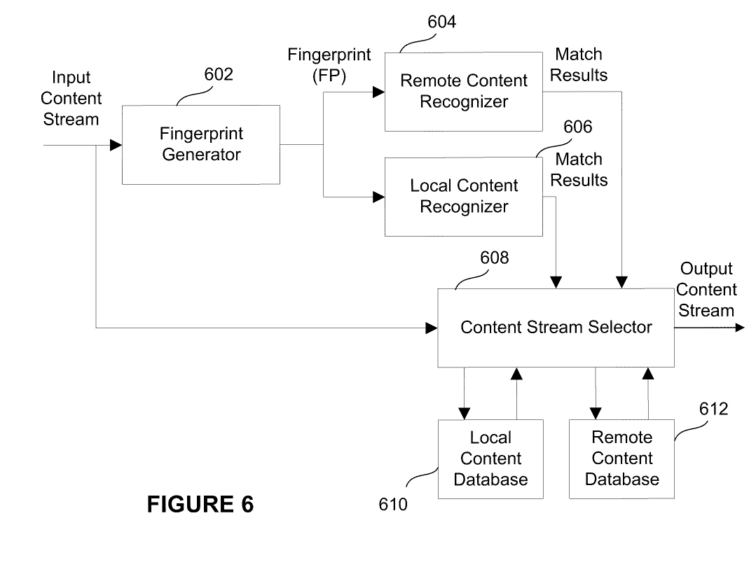

FIG. 6 depicts a flow diagram for a content filtering system that can be used to perform filtering procedures such as those shown in FIGS. 3 and 4. As shown in FIG. 6, only one content stream is shown. However, multiple input content streams can be monitored simultaneously. For example, a device such as a set-top box can potentially have multiple tuners that would allow multiple channels to be fingerprinted simultaneously.

Initially, the content stream enters the system at block 602. If the content stream contains metadata, such as a program identifier, and start and stop times, then fingerprinting is optional. In one example, the program is a commercial and the start and stop times are those corresponding to the commercial.

For a case where the content stream contains only multimedia data (e.g., audio and video data), a fingerprinting technique is used to compute a fingerprint of the content stream. This is performed by a fingerprint generator 602, which in one embodiment performs rolling recognition on the content stream.

The fingerprint (FP) is sent to one or more content recognizers which query a local and/or remote database of fingerprints, respectively, to search for matches. As shown in FIG. 6, one content recognizer is a remote content recognizer 604 and the other content recognizer is a local content recognizer 606. One or both of these recognizers can be employed. The local content recognizer 606 matches the content stream against a database of fingerprints that corresponds to all of the media data that has been fingerprinted by the system.

In one example, the local database of local content recognizer 606 contains all television content that has aired on a some of the user's favorite channels over the previous few months. The fingerprinted content stored in the database of the local content recognizer 606 can be associated with metadata that specifies which regions of the content streams were viewed and by which users. In one exemplary embodiment, the metadata that specifies which regions (also referred to as “segments”) of the content streams were viewed can be structures as a list of the form {(user_id₁, stream₁, start_time₁, stop_time₁), (user_id₁, stream₂, start_time₂, stop_time₂), . . . user_id₁, streamₙ, start_timeₙ, stop_timeₙ)}.

In one embodiment, a device can compute and store fingerprints of media content, such as television programs, when the device is not in use. The metadata specifying the content streams can thus be used to determine which content has been already viewed by users prior to playback.

Remote content recognizer 604 is a recognition server that the device communicates with over a network connection. For example, remote content recognizer 604 can correspond to a recognition server on the Internet that contains the fingerprints of repeated content (such as advertisements) that have been added by other users, content providers, and the like.

The output of the content recognizer(s) 604, 606 includes one or more match results. Particularly, for each time location in the input content stream, a corresponding match results specifies whether a match was found in the fingerprint database. If a determination is made that one or more matches have been identified, the match results data are returned to the filter. The returned match result data includes a stream id and start and stop locations of the time interval over which the match occurs. This information is communicated to a content stream selector 608, which processes the match results and performs filtering on the input content stream, which the content stream selector 608 also receives.

Referring again to FIG. 4, if real-time filtering is used, unless a programming guide is provided a priori, a determination that a clip repeats is made at the onset time of the second instance of the clip, such as at count=2. A determination that clip A of FIG. 4 is repeating, for example, occurs at the onset time of the second occurrence of clip A at count=2.

If not known ahead of time, the length of clip A is determined when the end of the “count=2” instance of clip A is reached, and the match results during the “count=2” instance of clip A does not contain any information about the duration of the repeating content. However, once the onset of the “count=3” instance of clip A is reached, the length of the repeating portion is known since this information can be pre-recorded in the fingerprint database when the length is first learned (e.g., at the end of the “count=2” instance of clip A). In one embodiment, the length of a repeated clip for the real-time filtering case in which alternate content is inserted as in FIG. 5, is known. This is because if the alternate content clip is chosen to be shorter than the actual repeated content duration, there is nothing to play (e.g., display) to the user between the end of the alternate content clip and the end of the repeated content filtering.

In one example implementation, the alternate media content is content that a user has not yet viewed, as determined based on one or more identifiers associated with a particular device. For example, the content replacing a portion of the original content can consist of a commercial that was recorded when the user was not using the device and has not yet seen.

Alternate content clips that are longer in duration than the filtered clip can be inserted as well. For example, multiple advertisements can be inserted in place of filtered content. It may be necessary to introduce an additional lag between the input content stream and the filtered content stream when the replacement content is longer than the original, filtered content.

The content stream selector 608 uses the match results from the recognizer(s) 604, 606 to determine when or if it is appropriate to insert alternate content or simply remove repeated content without adding alternate content. For the case where alternate content is added in place of filtered content, the content is obtained from an alternate content database. As shown in FIG. 6, one alternate content database is a local content database 610, which is maintained within or locally to a device incorporating the filter. Another alternate content database is a remote content database 612, which can be a database on a network such as network 112 of FIG. 1. One or both of the databases 610, 612 can be employed.

As described above, the local content database 610 can exist on the device performing the filtering or on a local network. Content is added to local content database 610 whenever repeated content is identified by a recognizer, such as remote content recognizer 604 or local content recognizer 606. For example, in FIG. 4 when the “count=2” onset of “clip A” is reached, the content stream selector 608 can begin sending the input stream to the local content database 610. When the end of the “count=2” instance of “clip A” is reached, the content selector 608 stops sending the input stream. Thus, the local content database 610 now contains a recording of “clip A”. More specifically, local content database 610 contains a table that maps the corresponding “stream id, start_time” from a content recognizer 604, 606 to the recording of clip A. Other information, such as the duration of clip A may also be stored in the local content database 610. Content that has already repeated twice can potentially be included in the local content database.

When the match results obtained from a content recognizer 604, 606, indicate that the input stream contains repeating content, the content selector can potentially communicate recorded content from the local content database 610 to the user via, for example, output interface 206 of FIG. 3. In the same way, repeating content can potentially be sent to and/or obtained from a remote content database 612.

Additional media items can be stored in local and remote content databases 610 and 612, by other users and/or content providers. In any case, based on the decision of the content selector 608, the output stream either consists of the input stream, alternate content from a local or remote database, or an “empty” content stream.

A rolling fingerprint can be continuously generated from the input stream and added to a local recognition server's database. Thus, no Internet connection is required since the recognition processor exists on the device itself. Moreover, because rolling recognition can be continuously performed on the input stream, it is possible to keep track of how many times the content has previously appeared in the input stream (e.g., number of matches within a local recognition database in local content recognizer 606). The filter can also operate in real-time. If a portion of the output stream is empty during the time at which the input stream is being filtered, a lag time can be introduced to simply time shift the program content. Offline filtering can be employed to avoid gaps in the content stream as well.

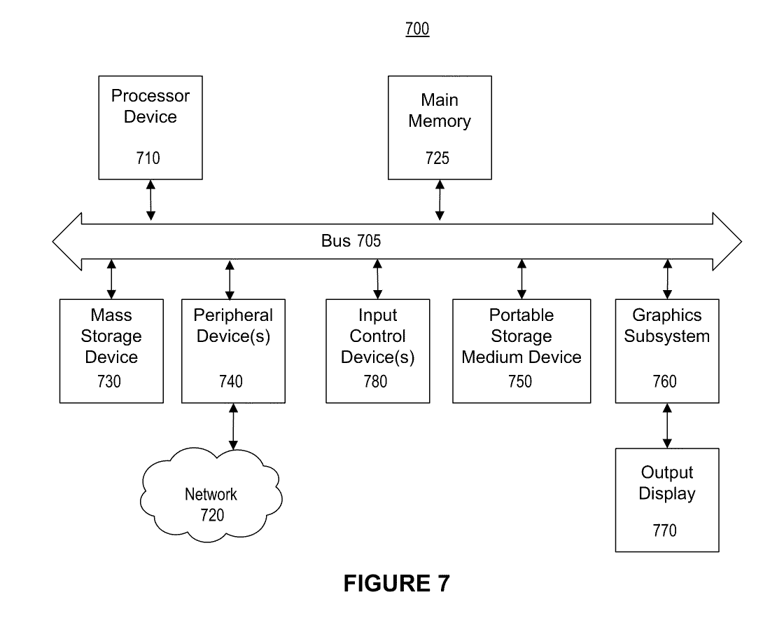

FIG. 7 is a block diagram of a general and/or special purpose computer 700, in accordance with some embodiments. The computer 700 may be, for example, a user device, a user computer, a client computer and/or a server computer, among other things.

The computer 700 preferably includes without limitation a processor device 710, a main memory 725, and an interconnect bus 705. The processor device 710 may include without limitation a single microprocessor, or may include a plurality of microprocessors for configuring the computer 700 as a multi processor system. The main memory 725 stores, among other things, instructions and/or data for execution by the processor device 710. The main memory 725 may include banks of dynamic random access memory (DRAM), as well as cache memory.

The computer 700 may further include a mass storage device 730, peripheral device(s) 740, portable storage medium device(s) 750, input control device(s) 780, a graphics subsystem 760, and/or an output display 770. For explanatory purposes, all components in the computer 700 are shown in FIG. 7 as being coupled via the bus 705. However, the computer 700 is not so limited. Devices of the computer 700 may be coupled through one or more data transport means. For example, the processor device 710 and/or the main memory 725 may be coupled via a local microprocessor bus. The mass storage device 730, peripheral device(s) 740, portable storage medium device(s) 750, and/or graphics subsystem 760 may be coupled via one or more input/output (I/O) buses. The mass storage device 730 is preferably a nonvolatile storage device for storing data and/or instructions for use by the processor device 710. The mass storage device 730 may be implemented, for example, with a magnetic disk drive or an optical disk drive. In a software embodiment, the mass storage device 730 is preferably configured for loading contents of the mass storage device 730 into the main memory 725.

The portable storage medium device 750 operates in conjunction with a nonvolatile portable storage medium, such as, for example, a compact disc read only memory (CD ROM), to input and output data and code to and from the computer 700. In some embodiments, the software for storing an internal identifier in metadata may be stored on a portable storage medium, and may be inputted into the computer 700 via the portable storage medium device 750. The peripheral device(s) 740 may include any type of computer support device, such as, for example, an input/output (I/O) interface configured to add additional functionality to the computer 700. For example, the peripheral device(s) 740 may include a network interface card for interfacing the computer 700 with a network 720.

The input control device(s) 780 provide a portion of the user interface for a user of the computer 700. The input control device(s) 780 may include a keypad and/or a cursor control device. The keypad may be configured for inputting alphanumeric and/or other key information. The cursor control device may include, for example, a mouse, a trackball, a stylus, and/or cursor direction keys. In order to display textual and graphical information, the computer 700 preferably includes the graphics subsystem 760 and the output display 770. The output display 770 may include a cathode ray tube (CRT) display and/or a liquid crystal display (LCD). The graphics subsystem 760 receives textual and graphical information, and processes the information for output to the output display 770.

Each component of the computer 700 may represent a broad category of a computer component of a general and/or special purpose computer. Components of the computer 700 are not limited to the specific implementations provided here.

Portions of the invention may be conveniently implemented by using a conventional general purpose computer, a specialized digital computer and/or a microprocessor programmed according to the teachings of the present disclosure, as will be apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the processes of the invention. The storage medium may include without limitation a floppy disk, a mini disk, an optical disc, a Blu-ray Disc, a DVD, a CD-ROM, a micro drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the invention. Such software may include without limitation device drivers, operating systems, and user applications. Ultimately, such computer readable media further includes software for performing aspects of the invention, as described above.

Included in the programming and/or software of the general and/or special purpose computer or microprocessor are software modules for implementing the processes described above.

While various example embodiments of the invention have been described above, it should be understood that they have been presented by way of example, and not limitation. It will be apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the FIGS. 1 through 7 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A filtering system for filtering a content stream, comprising:
a fingerprint generator adapted to generate at least one fingerprint based on a portion of an input content stream and communicate the at least one fingerprint to a content recognizer; and
a content stream selector adapted to receive a media content identifier from the content recognizer corresponding to the at least one fingerprint and perform filtering on a portion of the input content stream containing a clip, the clip corresponding to the media content identifier.

2. The system according to claim 1, wherein the clip is repeated within the input content stream.

3. The system according to claim 1, wherein upon the clip being located within the content stream a predetermined number of times, subsequent occurrences of the clip are removed by the filtering.

4. The system according to claim 1, wherein the filtering replaces the clip with alternate content.

5. The system according to claim 1, further comprising:
a storage device adapted to store a filtered content stream including the input content stream less the clip that was filtered by the content stream selector.

6. The system according to claim 5, further comprising:
a content database to store alternate content, and
wherein the content stream selector is further adapted to associate an alternate content identifier to the location in the input content stream corresponding to the clip removed by the content stream selector.

7. The system according to claim 5, further comprising:
a content database to store an alternate media item, and
wherein the content stream selector is further adapted to replace at least a portion of the clip removed by the content stream selector with the alternate media item.

8. A method for filtering a content stream, comprising the steps of:
generating at least one fingerprint based on a portion of an input content stream;
communicating the at least one fingerprint to a content recognizer;
receiving a media content identifier from the content recognizer corresponding to the at least one fingerprint; and
filtering a portion of the input content stream containing a clip, the clip corresponding to the media content identifier.

9. The method according to claim 8, wherein the clip is repeated within the input content stream.

10. The method according to claim 8, wherein upon the clip being located within the content stream a predetermined number of times, subsequent occurrences of the clip are removed by the filtering.

11. The method according to claim 8, wherein the filtering replaces the clip with alternate content.

12. The method according to claim 8, further comprising the step of:
storing a filtered content stream including the input content stream less the clip filtered by the filtering.

13. The method according to claim 12, further comprising the steps of:
storing alternate content, and
associating an alternate content identifier to the location in the input content stream corresponding to the clip removed by the filtering.

14. The method according to claim 12, further comprising the steps of:
storing an alternate media item, and
replacing at least a portion of the clip removed by the filtering with the alternate media item.

15. A non-transitory computer-readable medium storing instructions which, when executed by a processor, cause the processor to perform:
generating at least one fingerprint based on a portion of an input content stream;
communicating the at least one fingerprint to a content recognizer;
receiving a media content identifier from the content recognizer corresponding to the at least one fingerprint; and
filtering a portion of the input content stream containing a clip, the clip corresponding to the media content identifier.

16. The non-transitory computer-readable medium according to claim 15, wherein the clip is repeated within the input content stream.

17. The non-transitory computer-readable medium according to claim 15, wherein upon the clip being located within the content stream a predetermined number of times, subsequent occurrences of the clip are removed by the filtering.

18. The non-transitory computer-readable medium according to claim 15, wherein the filtering replaces the clip with alternate content.

19. The non-transitory computer-readable medium according to claim 15, the instructions further causing the processor to perform:
storing a filtered content stream including the input content stream less the clip filtered by the filtering.

20. The non-transitory computer-readable medium according to claim 19, the instructions further causing the processor to perform:
storing alternate content, and
associating an alternate content identifier to the location in the input content stream corresponding to the clip removed by the filtering.

21. The non-transitory computer-readable medium according to claim 19, the instructions further causing the processor to perform:
storing an alternate media item, and
replacing at least a portion of the clip removed by the filtering with the alternate media item.
